(19) United States
(12) Patent Application Publication
(10) Pub. No.: US 2006/0280055 A1
(43) Pub. Date: Dec. 14, 2006

(54) Laser power control and device status monitoring for video/graphic applications

(76) Inventors: Rodney D. Miller, Kernersville, NC (US); George Diniz, Liberty, NC (US); Barry L. Stakely, Snow Camp, NC (US); Doug Bartow, Greensboro, NC (US)

Correspondence Address: GAUTHIER & CONNORS, LLP, 225 FRANKLIN STREET, SUITE 2300, BOSTON, MA, 02110, US

(21) Appl. No.: 11/449,323

(22) Filed: Jun. 8, 2006

Related U.S. Application Data
(60) Provisional application No. 60/688,621, filed on Jun. 8, 2005.

(51) Int. Cl. G11B 7/00; H04B 10/00

(52) U.S. Cl. 369/44.11; 398/155; 369/124.01

(57) ABSTRACT

Signals, such as the +5V signal, the HPD signal, and LOS output from DDC, CEC, or HDMI signals are dynamically monitored, whereby a stand-by mode is entered in the absence of signal activity in any of the above-mentioned dynamically monitored signals. Such a monitoring architecture reduces power dissipation and allows the realization of low-power source/sink architectures.

### RELATED APPLICATION

This application claims priority to U.S. provisional application 60/688,621 filed Jun. 8, 2005, which is incorporated in its entirety herein by reference.

### BACKGROUND OF THE INVENTION

1. Field of Invention

The present invention relates generally to the field of improved high-definition multimedia interfaces. More specifically, the present invention is related to laser power control and device status monitoring for video/graphic applications.

2. Discussion of Prior Art

FIG. 1 illustrates a communication link 100 between a standard source (graphic/video source) 101 and a sink (display/receiver) 102. Communication between the graphic/video source 101 and the display/receiver 102 enables bi-directional transfer of signals that send graphic data from a source to a receiver and additional signals that send and receive control information between the source and receiver.

For consumer video and graphics systems, the above-mentioned communication link 100 (of FIG. 1) interfaces a TV and a set-top box, or a TV and a DVD player. In such a scenario, the extra control signals include signals related to the Data Display Channel (DDC), the Consumer Electronics Channel (CEC), and Hot Plug Detect (HPD). The DDC is used to ask the display what resolutions, frame rate, and clock rate are supported. The receiver/monitor responds back with what resolutions, frame rate, and clock rate it can support. HPD is used to determine if a device is added or removed from the link. CEC is used to pass additional control information from one device to another in the system. CEC allows the user to point their remote control at one unit but control another (for example, control your DVD player by pointing your remote at the TV).

HDMI (High Definition Multimedia Interface) is a video standard that is used in TVs, Monitors, DVD players, Audio/Video Receivers, and Set-Top boxes. FIG. 2 illustrates standard HDMI signals carried over a standard HDMI interface link. HDMI is a serial data interface that serializes the graphic information into three differential digital signals and includes separate connections for DDC, CEC and HPD. These signals will operate at non-determinate times and will need to be acted upon at each occurrence or change.

The following references provide a general teaching regarding various communication interfaces for digital displays.

The U.S. Patent Application Publication to Lee et al. (2006/0083518) provides for a fiber optic connection for digital displays. According to Lee et al., a DVI cable includes a source-side connector containing active circuitry such as a multiplexer (that interleaves pixel data and clock information) and a driver circuit that controls a laser transmitting an optical signal on an optical fiber.

The U.S. Patent Application Publications to Tatum et al. (2006/077778 and 2006/0067690) provide for consumer electronics with an optical communication interface. According to Tatum et al., a digital source device comprises a source controller, a transition minimized differential signaling (TMDS), an interface to receive a first end of an optical fiber, and an optical transmitter for receiving the electronic TMDS signals.

The U.S. Patent Application Publication to Galang et al. (2006/0036788) provides for a HDMI cable interface. Galang et al. teach an apparatus that is able to split and combine HDMI signals.

The U.S. Patent Application Publication to Green et al. (2003/0208779) provides for a system and method for transmitting digital video over an optical fiber. Green et al. teach a system that accepts input signals from a conventional DVI transmitter for transmitting video-encoded digital signals to a coarse wavelength division multiplexed (CWDM) optical transmitter.

Whatever the precise merits, features, and advantages of the prior art HDMI interfaces, none of them achieves or fulfills the purposes of the present invention.

### SUMMARY OF THE INVENTION

The present invention provides for an integrated circuit implemented in conjunction with a source, wherein the integrated circuit interfaces the source (e.g., a HDMI-capable DVD player) with a sink (e.g., a display device) over an optical link and comprises: a serializer combining interface signals received from said source and producing a serialized output to form one or more channels of data; an electrical-to-optical conversion unit receiving said serialized output and converting said serialized output to an optical output; and a power management unit invoking a power down and/or control signals based upon an absence of signal activity in any of the following dynamically monitored signals of a video interface (e.g., a video interface that is HDMI compliant): Data Display Channel (DDC), consumer electronic channel (CEC), input voltage, HDMI clock, and Hot Plug Detect (HPD). In an extended embodiment, the integrated circuit is housed within the source.

The present invention also provides for an integrated circuit implemented in conjunction with a sink (e.g., a display device), wherein the integrated circuit interfaces a source with the sink over an optical link and comprises: an optical-to-electrical conversion unit receiving said an optical input from said optical link and converting it to an electrical input of one or more channels of data; and a de-serializer isolating and outputting interface signals from said electrical input; and a power management unit invoking a power down and/or control signals based upon an absence of signal activity in any of the following dynamically monitored signals of a video interface (e.g., a video interface that is HDMI compliant): DDC, CEC, input voltage, HDMI clock, and HPD. In an extended embodiment, the integrated circuit is housed within the display device.

The present invention also provides for a method implemented at a source-side video interface comprising: dynamically monitoring any of, or a combination of, the following signals: an input voltage of a source associated with said video interface, a HPD signal from a sink, and a loss of signal (LOS) output from DDC, CEC, or HDMI signals; and invoking a stand-by mode and/or control signals in the absence of signal activity in any of said dynamically monitored signals.

The present invention also provides for a method implemented at a sink-side video interface comprising: dynamically monitoring any of, or a combination of, the following signals: an input voltage of a source, a HPD signal from a sink associated with said sink-side, and a LOS output from DDC, consumer electronic channel (CEC), or HDMI signals; and invoking a stand-by mode and/or control signals in the absence of signal activity in any of said dynamically monitored signals.

### BRIEF DESCRIPTION OF THE DRAWINGS

FIG. 1 illustrates a communication link between a standard source (graphic/video source) and a sink (display/receiver).

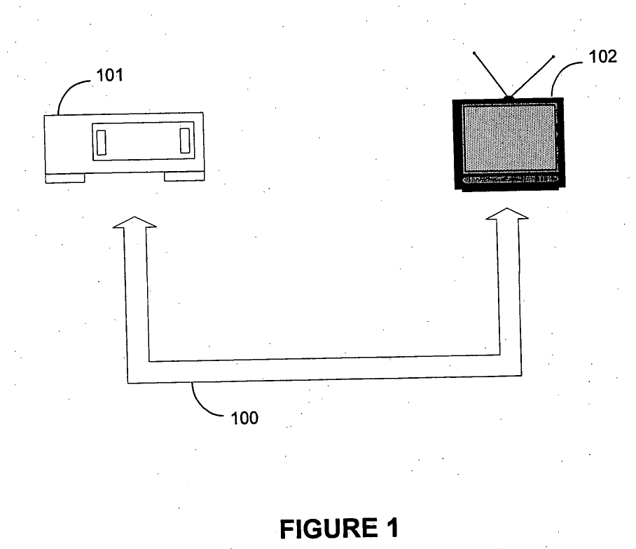

FIG. 2 illustrates standard HDMI signals carried over a standard HDMI interface link.

FIG. 3 illustrates an exemplary implementation of the present invention's HDMI interface that contains the interface signals that are combined through serialization, wherein the serialized data is in turn converted to an optical signal.

FIG. 4 illustrates a block diagram of the present invention's HDMI interface that converts the serialized data is into an optical signal via optical modules.

FIG. 5 illustrates the use of an embodiment wherein source 1 is connected to a sink via a first repeater (for example, an audio/video receiver) and source 2 is connected to the same sink via a second and the first repeater.

FIG. 6 illustrates a basic system interface for the present invention's algorithm.

FIG. 7 illustrates an exemplary implementation of the present invention's algorithm.

FIG. 8 illustrates a circuit representation of how a display and a monitor communicate to determine if a display is connected in the electrical interface.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. Also, throughout the specification, the terms Rigel and Source-Side are used interchangeably. Similarly, throughout the specification, the terms Polaris and Sink-Side are used interchangeably.

In a non-traditional HDMI interface link such as converting the HDMI into a single channel optical interface, or in an interface that is not HDMI but is required to communicate the DDC, CEC and Hot Plug signals, other measures are needed to ensure that the interface link is maintained—particularly that the link recognizes if some part of the system changes. This is important in an optical system that can operate in a low-power standby mode or given a condition that the optical link is broken and the optical sources need to be reduced in power.

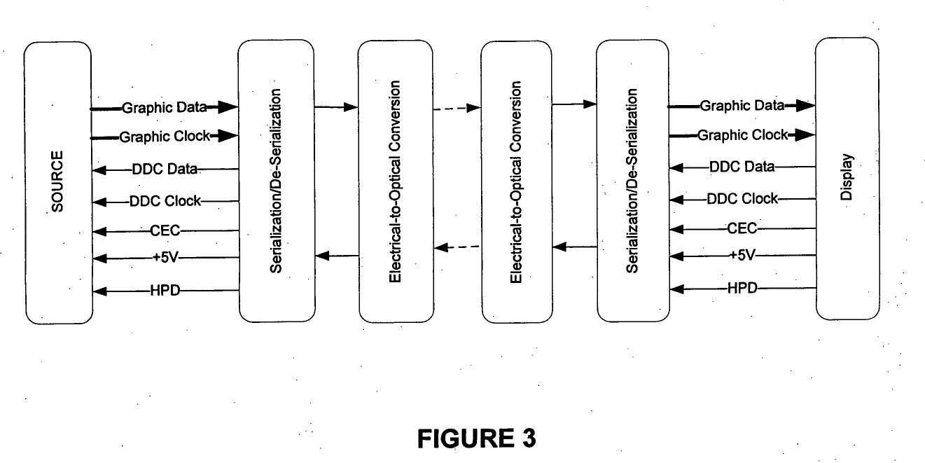

FIG. 3 illustrates an exemplary implementation of the present invention's HDMI interface that contains the interface signals that are combined through serialization, wherein the serialized data is in turn converted to an optical signal. In this configuration it is important to maintain the status of the interconnect to see if a source or display becomes connected or disconnected while keeping the laser inside the optical-to-electrical conversion unit in a low power state.

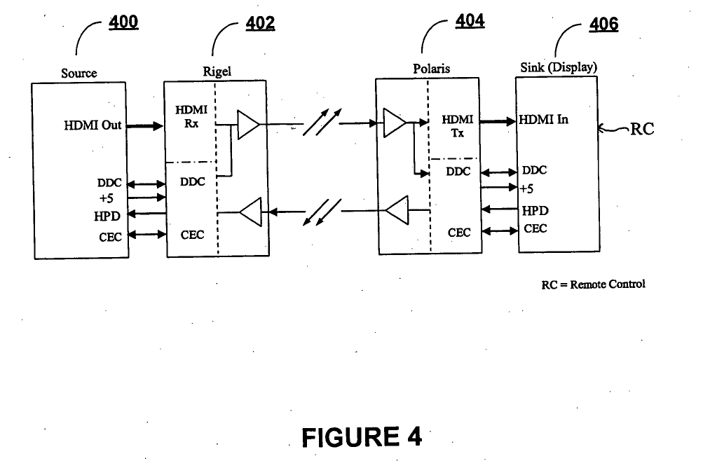

FIG. 4 illustrates a block diagram of the present invention's HDMI interface that converts the serialized data into an optical signal via optical modules. In FIG. 4, Rigel 402 represents the present invention's integrated circuit (IC) working in conjunction with the source 400 and Polaris 404 represents the present invention's IC working in conjunction with the sink 406. In a specific embodiment, the IC on the source-side (i.e., Rigel-side) is part of the source (e.g., the IC is part of a DVD player) and the IC on the sink-side (i.e., Polaris-side) is part of the sink (e.g., the IC is part of a display).

The laser link between the two optical modules needs to be constantly monitored in case there is a break in the fiber or damage to the fiber link. Such a break would result in possible exposure to the laser output. In most systems, the laser output is not of concern, except for the instance the human eye is exposed to the laser output. However, the present invention's architecture is designed to keep any exposure of the laser output to a minimum.

The present invention's communication link emulates a copper cable as the +5V and Hot Plug Detect (HPD) signal operation as described in the specification are ensured.

DDC and CEC Specific Signals

The HDMI specification lists that the signals that are transmitted between a source and a sink will include, three differential channels (six wires), a clock channel (two wires), SDA, SCL, CEC, DDC/CEC ground, +5V and HPD.

The Display Data Channel (DDC) is used by an HDMI link in the following ways:
provides a means for EDID data in a sink/repeater device to be read by a source device in order to configure the link; and
provides a communications channel for the HDCP authentication process, which includes the polling process used in the periodic validation of the authenticated device.

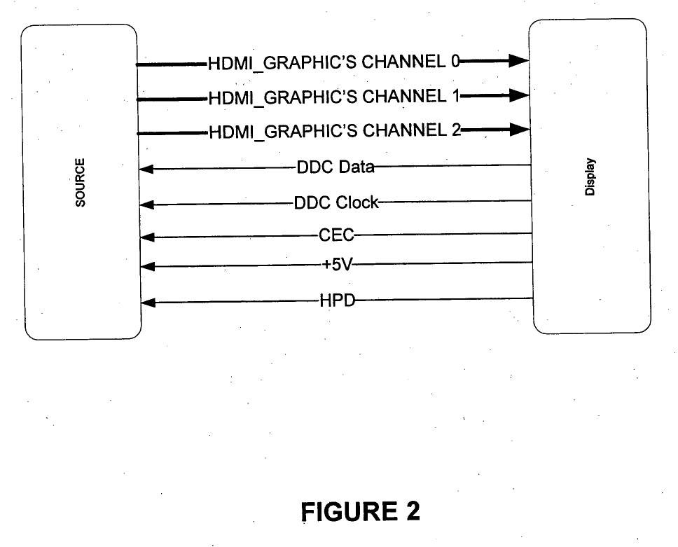

The Consumer Electronics Control (CEC) is a single wire bus, used to transmit high level commands to devices interconnected within an HDMI cluster. The bus is a multi-drop type with each device's CEC wire connected to all of the others. FIG. 2 illustrates how DDC and CEC busses interconnect in a sample HDMI cluster network.

Table 1 below contains a list of the DDC and CEC related signals, with a brief description of their operation.

TABLE 1
DDC/CEC signal descriptions

| DDC/CEC signal | Description of signal |
|---|---|
| SDA | I²C data port, used in the implementation of the DDC. |
| SCL | I²C clock port used in the implementation of the DDC. |
| CEC | A single wire serial bus used when the CEC is implemented in a |
| | device. |
| +5 V | Generated at a source device and monitored at a sink/repeater |
| | device. This signal must be detected before Hot Plug Detect can |
| | be asserted. |
| Hot Plug Detect | Generated at a sink/repeater device and when asserted (active |
| (HPD) | high) indicates to the source that the EDID may be read from the |
| | sink/repeater. It does not provide any information about the |
| | “power on” state of the sink or repeater device. |
| | This signal is also involved and monitored during the initial |
| | physical address generation of an HDMI device network. |
| | During this sequence, all the HPDs are de-asserted (set Low), |
| | and the address generation algorithm starting with the root |
| | device, writes the generated address into the Vendor Specific |
| | Data Block in the EDID ROM. After each device completes |
| | these steps, the HPD for that device is asserted (set High), until all |
| | devices in the network have had the physical addresses |
| | configured. |

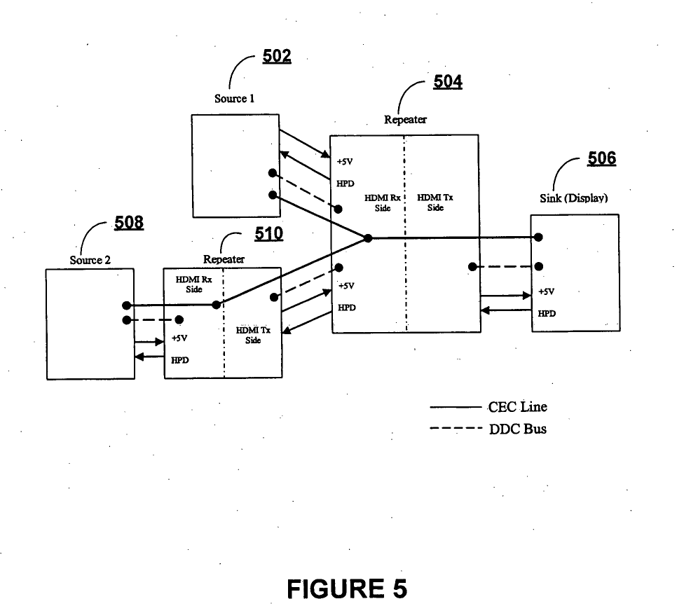

Although FIGS. 3 and 4 depict a source (i.e., a video source such as a DVD player) directly communicating with a sink (display), it should be noted that the teachings of the present invention can be extended to a scenario wherein a repeater is used in between the source and the sink. Such a scenario is depicted in FIG. 5, wherein source 1 502 is connected to sink 506 via a repeater 504 (for example, an audio/video receiver). In FIG. 5, source 2 508 is connected to sink 506 via repeaters 510 and 504. Regardless of the implementation, from the user's perspective, the present invention's HDMI link, whether used between a source and a sink or between a source/sink and a repeater, emulates a copper cable ensuring the required +5V and HPD operation.

Link Standby and Wake Up Modes

The Gotham link power dissipation will be reduced by invoking a powering down mode, in the absence of signal activity (CEC, DDC, HDMI), loss of +5V or HPD going inactive. This section will provide a description of the low power (Standby) mode architecture.

Initial Link Power On, with Both Ends of Link Connected to Respective Devices—

Source-Side (also referred to as the Rigel Side)—
1. Clear +5V and HPD signal registers to inactive states.
2. Rigel chip is fully powered on. All circuits are active.
3. Monitor +5V input.
4. When +5V is detected, send a “+5V_On” packet across the link, else Rigel goes to standby.
5. If “+5V_On” packet has been sent across the link to Polaris, then wait for a HPD response. Two possible outcomes are listed.
   a. If there is no response after a 10·Δt time interval then Rigel goes into Standby mode. Rigel awakes periodically to resend “+5V_On” packet to check for an HPD response from Polaris. The time interval between re-checking is Δt.
   b. Polaris responds by sending the “HPD_active” packet. Rigel receives and stores this signal state and then outputs it to be used by a “source device”. Rigel holds this HPD state until it receives a “HPD_inactive” packet or the power is turned off.
6. At this point Rigel will monitor the loss of signal (LOS) output from the optical receiver, CEC, DDC and HDMI signals. LOS=1, or no activity on the HDMI signals or CEC line, will cause Rigel to go into Standby mode.

Sink-Side (also referred to as the Polaris-Side)—
1. Clear +5V and HPD signal registers to inactive states.
2. Polaris chip is fully powered on. All circuits are active.
3. Wait to receive the “+5V_On” packet from Rigel.
   a. No “+5V_On” packet received after a 10·Δt time interval, then Polaris goes to Standby with +5V and HPD signals kept in the inactive state.
   b. “+5V_On” packet received. Store this state in Polaris, and output the +5V signal to the Sink device. Then wait for HPD response from Sink. Two possible outcomes while waiting for HPD response.
      i. No HPD response after a predetermined time interval. Polaris will go to Standby. It will wake up periodically to check if there is a HPD response.
      ii. HPD=1 is detected by Polaris. Polaris sends the “HPD_active” packet to Rigel.
   c. After “HPD_active” packet is sent to Rigel and output to Source, link is established. Polaris will now monitor the LOS signal, CEC, and DDC signals. LOS=1, or no activity on the HDMI signals or CEC line, will cause Polaris to go into Standby mode.

Rigeland Polaris are Powered On—

There are five different cases to consider in this category that represent how each side of the link can be disconnected and reconnected, while being powered on.

Case 1: Source (Rigel) Disconnected and Sink (Polaris) Remains Connected.
1. +5V signal from HDMI connector into Rigel goes away
2. Rigel detects and records “+5V_Off”. Rigel sends “+5V_Off” packet to Polaris.
3. Polaris records the “+5V_Off” state and outputs +5V signal equal to zero. +5V is removed going into the monitor (sink)
4. Monitor (sink) responds to no+5V signal present, by setting HPD to logic 0.
5. Polaris stores “+5V_Off” and HPD=logic 0.
6. Under these conditions, CEC can not initiate communications or wake up Polaris.
7. Polaris optical Link is powered down
8. Rigel optical Link is powered down
9. Both TxDisable bits are monitored to power up the system.

Case 2: Rigel Re-Connects and Polaris Remains Connected.
1. +5V signal is detected by Rigel from HDMI input
2. Rigel's optical outputs are powered up and “training sequence” is sent
3. Polaris “TxDisable”]becomes active, Polaris powers up
4. Rigel sends “+5V_On” packet to Polaris.
5. Polaris receives and records the “+5V_On” state and outputs +5V to the display (Sink).
6. HPD will go High (active) from the Sink and will be read by Polaris.
7. Polaris will send HPD_active packet to Rigel.
8. Link is re-established. The link will go into Standby if no other signal activity is present after this sequence after a specified amount of time.

Case 3: Rigel is Connected and Polaris Disconnects.
1. HPD signal from display (Sink) will go low (inactive).
2. Polaris will send “HPD_inactive” packet to Rigel. Polaris will maintain the “+5V_On” state that goes to the display (Sink).
3. Rigel will receive and record the “HPD_inactive” state. Rigel will output the HPD=0 signal to the Source.
4. Polaris Optical Tx will turn OFF, but maintain the +5v signal to the display.
5. Rigel Optical Tx will turn OFF, will monitor +5V for change and continue to keep HPD=0.
6. Both Rigel and Polaris will monitor TxDisable pin.

Case 4: Rigel Connected and Polaris Re-Connects
1. The “+5V_On” state is still stored in Polaris from the prior condition of Case 3 (Else go to case 5/6).
2. Polaris will detect HPD High (active).
3. Polaris will activate optical TX and send “training sequence”.
4. Rigel will see TxDisable active and Active Optical Tx and send status update.
5. Polaris will send the “HPD_active” packet to Rigel.
6. Rigel will send status update to Polaris (verify the +5V is still present).
7. Rigel receives the “HPD_active” packet and records that state. Rigel then outputs the HPD=1 signal to the Source.
8. Link is re-established and will go into Standby if no other signal activity is present.

Case 5: Rigel Disconnected and Polaris Disconnected
1. Rigel will detect the +5V signal going to logic “0”.
2. Rigel will send the “+5V_Off” packet to Polaris.
3. Polaris will receive and record the “+5V_Off” state.
4. The HPD signal input to Polaris will be low (because Sink is disconnected). Polaris will store the “HPD_inactive” state.
5. Polaris sends the “HPD_inactive” packet to Rigel.
6. Rigel receives and records the “HPD_inactive” state. HPD=0 signal will be output from Rigel.
7. Rigel optical output will turn off.
8. Polaris optical output will turn off.
9. Both Rigel and Polaris will monitor TxDisable.

Rigel “Powered Off” with Polaris On—

This represents the case where the Source side of the link has been powered off (OFF button), while the Sink side of the link is still powered on.
1. Rigel is the Master in this link. This means that Rigel will always send an update to the +5V packet to Polaris at a certain time interval, Δt, which is to be determined.
2. Polaris will respond back with an update of the HPD packet.
3. If Rigel does not receive a response from Polaris after a time period of 10·Δt, then it will consider Polaris powered off.
   a. Rigel will clear and record the new HPD=“HPD_inactive”.
   b. Rigel will set the HPD output to the Sink, to logic 0.
   c. Rigel will go to Standby.

Polaris Powered Off with Rigel Powered On—

This represents the case where the Sink side of the link has been powered off, while the Source side remains powered on.
1. Polaris expects to receive an updated +5V packet every Δt time interval.
2. If Polaris does not receive an updated +5V packet after a time interval equal to 10·Δt, then Polaris will consider Rigel powered off.
   a. Polaris will clear and record the “+5V_Off” state.
   b. Polaris will remove the +5V from its output, which is connected to the Sink.
   c. Polaris will detect that the Sink has made HPD inactive. It will record this value as the last HPD state.
   d. Polaris will go to Standby.

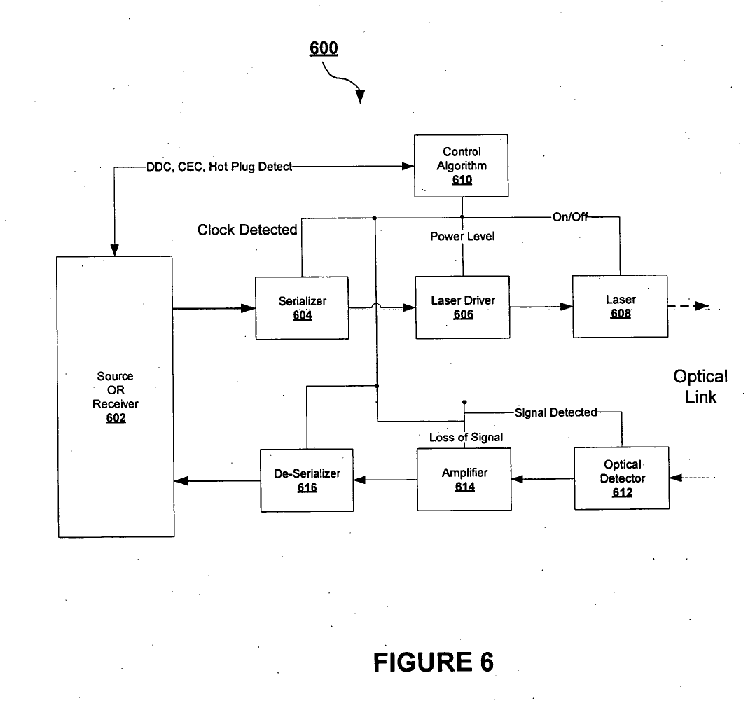

FIG. 6 illustrates a basic system interface 600 for the algorithm. In FIG. 6, the sterilizer 604 serializes and combines the interface signals from the source 602. The serialized signals are fed into an electrical-to-optical conversion unit comprising a laser driver 606 and laser 608, whose output is sent via the optical link. The control algorithm 610 of the present invention controls the power level of the laser and determines when and how to: (1) activate the laser 608 from stand-by mode, (2) put the laser 608 in stand-by mode, (3) indicate when components are added or removed from the link, and (4) determine if the fiber has been damaged. The setup shown in FIG. 6 also shows an optical detector 612 to detect an optical signal, an amplifier 614 to amplify the detected signal, and a de-serializer 616 to de-serialize and extract the interface signals, which are then presented to the sink (e.g., a display).

In one embodiment, the teachings of the present invention are implemented in an integrated circuit. In one scenario, the integrated circuit is implemented in conjunction with a source (wherein the integrated circuit interfaces the source (e.g., a HDMI-capable DVD player) with a sink (e.g., a display device) over an optical link) and comprises: a serializer combining interface signals received from said source and producing a serialized output to form one or more channels of data; an electrical-to-optical conversion unit receiving said serialized output and converting said serialized output to an optical output; and a power management unit (not shown) invoking a power down and/or control signals based upon an absence of signal activity in any of the following dynamically monitored signals of a video interface (e.g., a video interface that is HDMI compliant): Data Display Channel (DDC), consumer electronic channel (CEC), input voltage, HDMI clock, and Hot Plug Detect (HPD). In an extended embodiment, the integrated circuit is housed within the source.

In another embodiment, the integrated circuit is implemented in conjunction with a sink (e.g., a display device), wherein the integrated circuit interfaces a source with the sink over an optical link. In this embodiment, the integrated circuit comprises: an optical-to-electrical conversion unit receiving said optical input from said optical link and converting it to an electrical input of one or more channels of data; and a de-serializer isolating and outputting interface signals from said electrical input; and a power management unit invoking a power down and/or control signals based upon an absence of signal activity in any of the following dynamically monitored signals of a video interface (e.g., a video interface that is HDMI compliant): Data Display Channel (DDC), consumer electronic channel (CEC), input voltage, HDMI clock, and Hot Plug Detect (HPD). In an extended embodiment, the integrated circuit is housed within the display device.

The present invention also provides for a method implemented at a source-side video interface comprising: dynamically monitoring any of, or a combination of, the following signals: an input voltage of a source associated with said video interface, a hot plug detect (HPD) signal from a sink, and a loss of signal (LOS) output from Data Display Channel (DDC), consumer electronic channel (CEC), or HDMI signals; and invoking a stand-by mode and/or control signals in the absence of signal activity in any of said dynamically monitored signals.

The present invention also provides for a method implemented at a sink-side video interface comprising: dynamically monitoring any of, or a combination of, the following signals: an input voltage of a source, a hot plug detect (HPD) signal from a sink associated with said sink-side, and a loss of signal (LOS) output from Data Display Channel (DDC), consumer electronic channel (CEC), or HDMI signals; and invoking a stand-by mode and/or control signals in the absence of signal activity in any of said dynamically monitored signals.

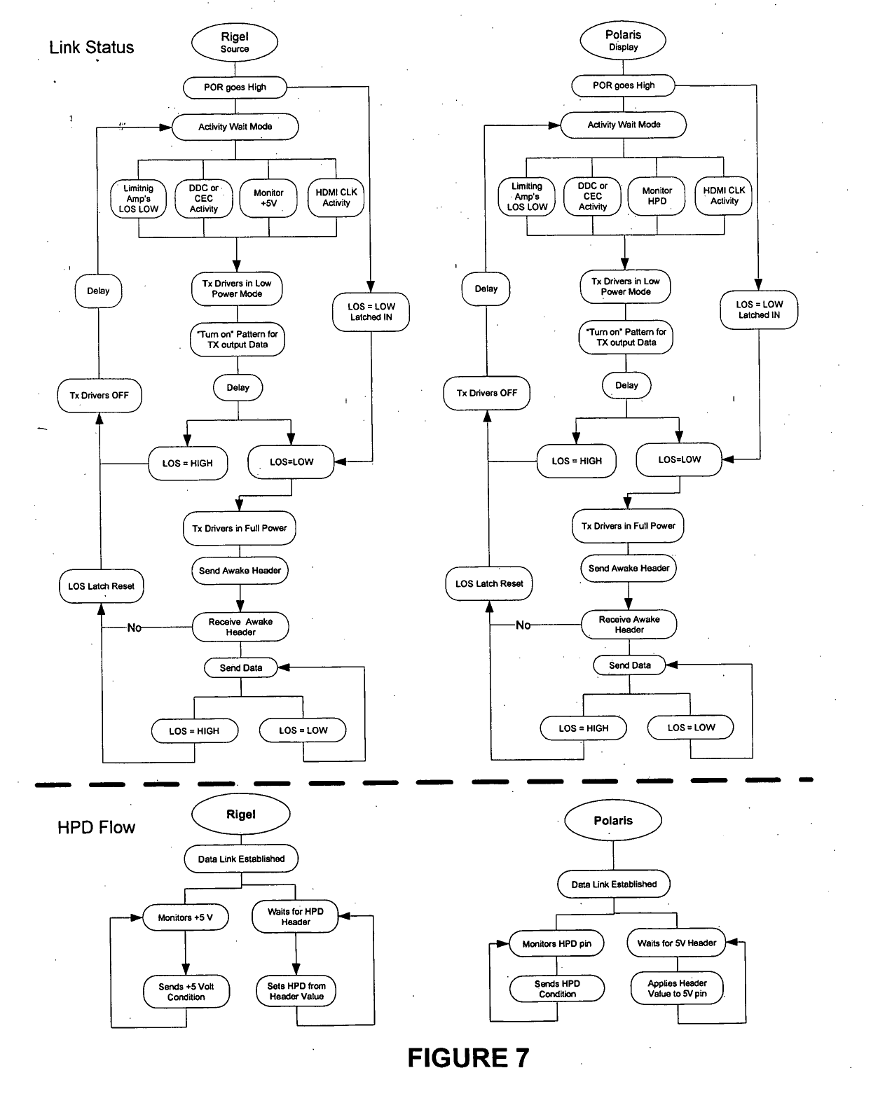

FIG. 7 illustrates an exemplary embodiment of the present invention's algorithm. FIG. 7 illustrates two flows: the top-left depicts the functionality of the Rigel block, the block associated with the source-side of the link, while the top-right depicts the functionality of the Polaris block, the block associated with the receiver-side of the link. The bottom part of FIG. 7 illustrates the functionality of the Rigel and Polaris side to monitor the HPD signal.

The left side of the algorithm of FIG. 7 represents one possible code that is implemented in the Rigel chip (the chip that is on the source side of the link). A general overview of this flow is as follows. At power-up the Power on Reset (POR) signal goes HIGH representing a chip power-on. The algorithm then waits for an activity to occur before allowing the laser drivers to activate. The link is active by: (1) the Loss of Signal (LOS) goes low (this indicates that a laser signal is coming from the other side of the link, the display (Polaris)), (2) the DDC or CEC becomes active, (3) the monitor +5V checks to see if a source is powered up, (4) any activity on the HDMI clock.

After one of these conditions is met, the laser is powered on in “Low power mode.” This is used to make sure that the other end of the link is connected before the full laser power is applied.

At this point, a header is sent across the optical link to activate the Polaris chip set and then wait for Polaris to send data back. LOS will go LOW when the Polaris chip is active. If no activity is seen on the LOS, after a delay period the laser drivers turn off.

When the link is established, the laser is then put in full power mode and normal HDMI and header information are sent to Polaris. The link will then shut down if LOS goes high, indication that the link is broken or the Display is turned off. A very similar algorithm is used on the Polaris side of the link as shown in the right side of FIG. 7.

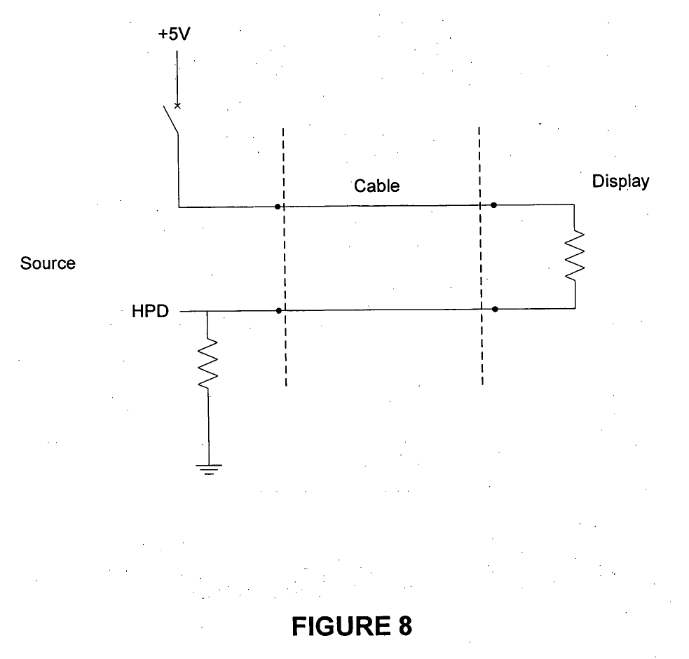

FIG. 8 is a circuit representation of how a display and a monitor communicate to determine if a display is connected in the electrical interface. The source supplies a 5V signal to the +5V line in the HDMI interface the display may have some logic or just a series resistor to indicate that it is connect in the circuit. The 5 volts is then provided back to the source as the HPD (Hot Plug Detect pin). A weak pull down is located on HPD to reduce any false signals. This interface has to be provided the same way across the optical interface.

### CONCLUSION

A system and method has been shown in the above embodiments for the effective implementation of laser power control and device status monitoring for video/graphic applications. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by specific hardware.

1. An integrated circuit implemented in conjunction with a source, said integrated circuit interfacing said source with a sink over an optical link, said integrated circuit comprising:
a serializer combining interface signals received from said source and producing a serialized output of one or more channels of data;
an electrical-to-optical conversion unit receiving said serialized output and converting said serialized output to an optical output; and
a power management unit invoking a power down and/or control signals based upon an absence of signal activity in any of the following dynamically monitored signals of a video interface: Data Display Channel (DDC), consumer electronic channel (CEC), input voltage, HDMI clock, and Hot Plug Detect (HPD).

2. An integrated circuit as per claim 1, wherein said video interface is HDMI compliant.

3. An integrated circuit as per claim 1, wherein said integrated circuit further comprises means for monitoring a laser interface in said electrical-to-optical conversion unit.

4. An integrated circuit as per claim 1, wherein said sink is a display device.

5. An integrated circuit as per claim 1, wherein said integrated circuit is housed within said source.

6. An integrated circuit implemented in conjunction with a sink, said integrated circuit interfacing a source with said sink over an optical link, said integrated circuit comprising:
an optical-to-electrical conversion unit receiving said optical input from said optical link and converting it to an electrical input of one or more channels of data; and
a de-serializer isolating and outputting interface signals from said electrical input; and
a power management unit invoking a power down and/or control signals based upon an absence of signal activity in any of the following dynamically monitored signals of a video interface: Data Display Channel (DDC), consumer electronic channel (CEC), input voltage, HDMI clock, and Hot Plug Detect (HPD).

7. An integrated circuit as per claim 6, wherein said video interface is HDMI compliant

8. An integrated circuit as per claim 6, wherein said sink is a display device.

9. An integrated circuit as per claim 6, wherein said integrated circuit is housed within said display device.

10. A method implemented at a source-side video interface comprising:
a. dynamically monitoring any of, or a combination of, the following signals: an input voltage of a source associated with said video interface, a hot plug detect (HPD) signal from a sink, and a loss of signal (LOS) output from Data Display Channel (DDC), consumer electronic channel (CEC), or HDMI signals; and
b. invoking a stand-by mode and/or control signals in the absence of signal activity in any of said dynamically monitored signals.

11. A method as per claim 10, wherein said video interface is HDMI compliant.

12. A method as per claim 10, wherein said method further comprises the step of periodically resending said input voltage signal to check for a HPD response from said sink.

13. A method as per claim 10, wherein said video interface is part of a display device.

14. A method implemented at a sink-side video interface comprising:
a. dynamically monitoring any of, or a combination of, the following signals: an input voltage of a source, a hot plug detect (HPD) signal from a sink associated with said sink-side, and a loss of signal (LOS) output from Data Display Channel (DDC), consumer electronic channel (CEC), or HDMI signals; and
b. invoking a stand-by mode and/or control signals in the absence of signal activity in any of said dynamically monitored signals.

15. A method as per claim 14, wherein said video interface is HDMI compliant.

16 A method as per claim 14, wherein said sink is a display device.
